(19) United States
(12) Patent Application Publication
(10) Pub. No.: US 2023/0138515 A1
(43) Pub. Date: May 4, 2023

(54) Airfield Ground Light with Integrated Light Controller That Employs Powerline Communications and Sensors

(71) Applicant: ADB SAFEGATE Americas, LLC, Colunbus, OH (US)

(72) Inventors: Nathan Wright, Gahanna, OH (US); Timothy Troester, Worthington, OH (US); Brian Mueller, Columbus, OH (US); Timothy DeLashmutt, Hilliard, OH (US); Christopher Paul Lenihan, Galloway, OH (US); Daryl M. Dininno, Baltimore, OH (US); Javier E. Angulo, Delaware, OH (US); Robert Scites, Columbus, OH (US)

(21) Appl. No.: 17/966,452

(22) Filed: Oct. 14, 2022

Related U.S. Application Data
(60) Provisional application No. 63/275,235, filed on Nov. 3, 2021.

(51) Int. Cl. G01M 11/08; G01M 3/32; G01M 5/00; G01M 3/04; F21V 23/04

(52) U.S. Cl. CPC G01M 11/081; G01M 3/3272; G01M 5/0066; G01M 3/04; F21V 23/0442; F21W 2131/103

(57) ABSTRACT

Disclosed in an example embodiment herein is an airfield luminaire, comprising a housing, a light source in an interior of the housing, a sensor for sensing a condition associated with the housing, and control logic comprising a processor coupled with the light source and the sensor. The control logic is operable to obtain data from the sensor and determine a status of the airfield luminaire. In another example embodiment, a controller is operable to receive data representative of sensor data from the plurality of airfield lighting fixtures and determine the status of a selected one of the plurality if lighting fixtures based on the sensor data. In yet another example embodiment control logic that comprises a processor is operable to determine the present light output of a LED based on aging rate and amount of time the LED is operated at a plurality of temperatures.

### CROSS REFERENCE TO RELATED APPLICATIONS

This application claims the benefit under 35 U.S.C. § 119 of U.S. Provisional Application No. 63/275,235, filed Nov. 3, 2021. The contents of the aforementioned application is hereby incorporated by reference herein in its entirety.

### TECHNICAL FIELD

The present disclosure relates generally to airfield ground lights.

### BACKGROUND

Regulatory agencies such as the Federal Aviation Administration (FAA), International Civil Aviation Organization (ICAO), and Civil Aviation Administration of China (CAAC) set requirements for airfield lighting systems. Systems that do not meet the requirements must be taken out of service. This requires monitoring of airfield lighting systems.

### SUMMARY OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an airfield luminaire, comprising a housing, a light source in an interior of the housing, a sensor for sensing a condition associated with the housing, and control logic comprising a processor coupled with the light source and the sensor. The control logic is operable to obtain data from the sensor and determine a status of the airfield luminaire. Examples of the status that can be determined include but are not limited to whether there is a leak in the housing, the structural integrity of the airfield luminaire, a malfunction of the airfield luminaire, a tilt angle with respect to gravity of the light source, a directional orientation of the light source, and whether the light source is correctly aimed.

In accordance with an example embodiment, there is disclosed herein an apparatus comprising a controller operable to communicate with a plurality of airfield lighting fixtures. The circuit, the controller comprises logic comprising a processor operable to receive data representative of sensor data from the plurality of airfield lighting fixtures and determine the status of a selected one of the plurality of lighting fixtures based on the sensor data. Examples of the status that can be determined include but are not limited to structural integrity of an airfield lighting fixture and/or a fixture malfunction, which in an example embodiment is based on a comparison of temperature data from the selected one of the plurality of airfield lighting fixtures with other airfield lighting fixtures of the plurality of airfield lighting fixtures.

In accordance with an example embodiment, there is disclosed herein an apparatus, comprising control logic that comprises a processor. The processor is operable to obtain a light emitting diode (“LED”) light output aging rate for an LED, and measure operating temperature and an amount of time the LED operates at the operating temperature, which can be in real time, during operation of the LED. The controller is further operable to determine a present LED light output based on calculating the amount of degradation for a plurality of measured temperatures and a time period operating at the plurality of temperature from the LED aging rate for the plurality of temperatures from an initial light output.

### BRIEF DESCRIPTION OF THE DRAWINGS

The accompanying drawings incorporated herein and forming a part of the specification illustrate the example embodiments.

FIG. 1 is a simplified functional block diagram illustrating an example of a light system that can be employed as an airfield luminaire.

FIG. 2 is a simplified functional block diagram illustrating an example of a lighting system that can be employed as an airfield luminaire that communicates control signals and/or sensor data over a powerline.

FIG. 3 is a block diagram illustrating an example of a light fixture with an integrated controller that employs powerline communication and illustrates different types of sensors that can be employed in the light fixture.

FIG. 4 is a block diagram illustrating an example of a light fixture with an additional wireless communication interface for enabling communication with portable mobile devices.

FIG. 5 is a block diagram illustrating an example of a light fixture with a plurality of temperature sensors within the housing.

FIG. 6 is a block diagram illustrating an example of a system comprising a remote computing device operable to determine the status of a plurality of light fixtures.

FIG. 7 is a block diagram illustrating an example of a computer system upon which an example embodiment can be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed in an example embodiment herein is an airfield luminaire with sensors employed for determining the status of the light. The airfield light can be any type of airfield luminaire, including but not limited to a Runway centerline light (RCL), runway edge light (REL), e.g., High Intensity Runway Lights (HIRL), Medium Intensity Runway Lights (MIRL), and Low Intensity Runway Lights (LIRL), taxiway centerline light, taxiway edge light, Runway End Identifier Light (REIL), Clearance Bar Lights. Runway Guard lights, Medium-intensity Approach Light with Runway alignment (MALSR), Medium-intensity Approach Light with Sequenced Flashing lights (MALSF), Short Approach Light (SAL), Simplified Short Approach Light (SSAL), Simplified Short Approach Light with Runway Alignment Indicator Lights (SSALR), Simplified Short Approach Lighting System with Sequenced Flashing Light (SSALF), Omni directional Approach Light (ODAL), Lead-in Light (LDIN), Visual Approach Slope Indicator (VASI), Precision Approach Path Indicator (PAPI), Takeoff and Hold light (THL), Touchdown Zone light (TDZL), or a sign.

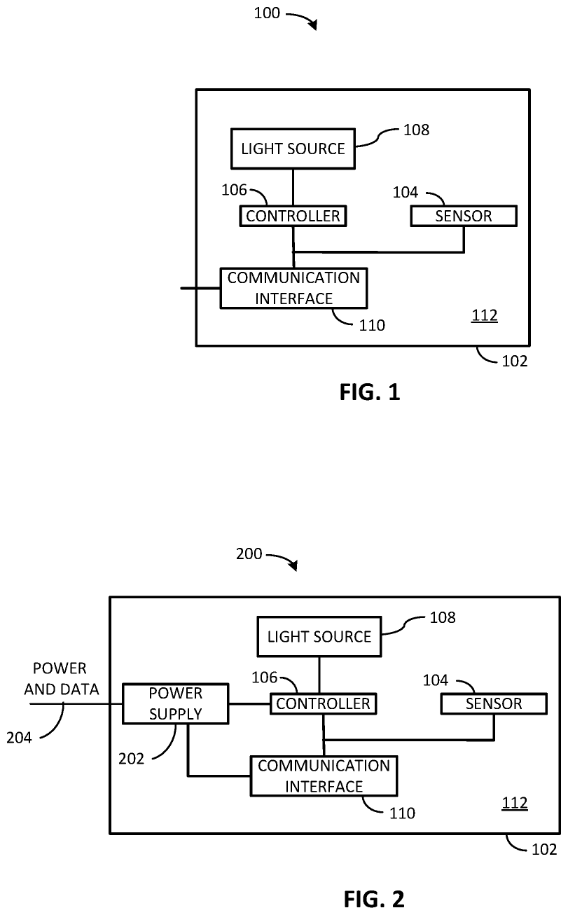

Referring to FIG. 1, there is illustrated a simplified functional block diagram illustrating an example a lighting fixture 100 that can be employed as an airfield luminaire. The light fixture 100 comprises a housing 102, a sensor 104, a controller 106, a light source 108, and a communication interface 110.

The housing 102 can be any desired shape depending on the type of light. In an example embodiment, the housing 102 comprises clear sections (not shown), such as lenses which can be clear or colored, for directing light from the light source 108 outside of the housing 102.

The sensor 104 senses an environmental conditions in the interior 112 of the housing 102. In example embodiments, the sensor 104 is selected from a group consisting of a combination of a temperature sensor and a pressure sensor for sensing pressure inside the airfield luminaire, a moisture sensor for sensing a leak inside the airfield luminaire, a vibration sensor, an inclinometer, and a magnetic field sensor.

A controller 106 comprising logic for performing the functionality described herein is coupled with the sensor 104. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by processor.

The controller 106 is operable to control the operation of the light source 108. For example, the controller 106 can control the intensity and/or a flash rate of light from source 108.

Light source 108 can be any suitable type of light source 108, such as, for example, an incandescent light, halogen light, or a light emitting diode (“LED”). For ease of illustration, it is assumed that the light source 108 includes any associated components that are employed to operate the source of light such as transformers and/or other electronics that provides the appropriate current and/or voltage to the light source 108. In some embodiments the light source 108 is omni-directional while in other embodiments the light source 108 is directional, such as for example unidirectional or bi-directional.

As will be described herein, the controller 106 is operable to determine a status of an airfield luminaire based on data obtained from the sensor 104. The controller 106 sends data to an external, remote computing system, such as for example, an Airfield Lighting Control & Monitoring System (“ALCMS”) via communication interface 110. The data sent by the controller 106 via the communication interface 110 can send data representative of the current operational state of the light source 108 (e.g., on/off, blinking, intensity, etc.) and/or as will be described in more detail herein, infra, cause status data determined from data obtained from sensor 104 to be sent to a remote, external computing system (such as for example an ALCMS). In an example embodiment, data from sensor 104 is sent to a remote, external controller via the communication interface 110.

Communication interface 110 can be any type of communication interface for communicating with an external, remote computer system. For example, communication interface 110 can be a wired and/or wireless interface. The communication link (not shown) between the communication interface 110 and an external, remote computing system can be a wired, wireless, or a combination of wired and wireless links.

In an example embodiment, the sensor 104 comprises a temperature sensor and a pressure sensor, and the controller 106 can determine if there is a leak in the housing 102 by comparing changes in temperature obtained from a temperature sensor with changes in pressure obtained from a pressure sensor. Because the housing 102 is sealed, a temperature increases or decreases without a corresponding increase or decrease in pressure can indicate a leak in the housing 102. For example if the temperature increased or decreases by more than ten degrees Celsius without a change in pressure, the controller 106 can determine there is a leak in the housing 102. In an example embodiment, the ratio of the temperature and pressure is computed and stored by controller 106. The ratio of temperature and pressure should be constant, so if the controller 106 determines the ratio has been changing over time, or there is a sudden change, by more than a predetermined amount, a leak can be detected. The predetermined amount can be based on a fixed number of degrees (e.g., 10° C.), a percentage change (e.g., 10% or more), and/or based on statistical analysis (e.g., more than 1, 2, or 3 standard deviations). Similarly, a change in pressure without a corresponding change in temperature may also indicate a leak I the housing 102. If a leak is detected, the controller 106 can take corrective action such as sending a message to an external, remote computing device to report the leak and initiate an inspection and/or repair of the light fixture 100 and/or turning the light fixture 100 off.

In another example embodiment, the sensor 104 comprises a moisture sensor and the controller 106 can determine if there is a leak in the housing 102 of the airfield luminaire based on moisture data obtained from the moisture sensor. The moisture sensor can be any type of sensor capable of detecting liquid and/or humidity within the interior 112 of housing 102. Examples of moisture sensors include, but are not limited to a water sensor and/or a hygrometer. Some embodiments include a combination of a water sensor or a hygrometer. For sensors that detect water, any water detected in the interior 112 of housing 102 can be indicative of a leak. For sensors that detect humidity, the controller 106 may also employ data from a temperature sensor for determining relative humidity. Since the housing 102 is sealed, the moisture content of the interior 112 of the housing 102 should not change, thus a change in temperature without a corresponding change in relative humidity can be indicative of a leak. For example, as temperature increases, the relative humidity should decrease. For example, if the temperature changes by more than ten degrees Celsius without a corresponding change in relative humidity, the controller 106 can determine there is a leak in housing 102. If a leak is detected, the controller 106 can take corrective action such as sending a message to an external, remote computing device to report the leak and initiate an inspection and/or repair of the light fixture 100 and/or turning the light fixture 100 off.

Alternatively, the controller 106 can compute the absolute humidity and/or the specific humidity of the interior 112 of the housing 102 and can determine if there is a leak in housing 102 by detecting changes in the absolute humidity and/or the specific humidity by more than a predetermined amount. The predetermined amount of change for absolute humidity can be a fixed amount (e.g., more than 2 g/cubic meter (g water vapor/cubic meter of air), a fixed percentage (e.g. more than 10%, or a statistically computed amount such as 1, 2, or 3 standard deviations). The predetermined amount of change for specific humidity can be a fixed number, based on a percentage, or based on statistical variations. For example, for specific humidity a change of more than by more 2 g/kg (g air/kg water), or a ten percent change, or a 1, 2, or 3 standard deviation can be indicative of a leak in housing 102. If a leak is detected, the controller 106 can take corrective action such as sending a message to an external, remote computing device to report the leak and initiate an inspection and/or repair of the light fixture 100 and/or turning the light fixture 100 off.

In yet another example embodiment, the sensor 104 is a vibration sensor, such as for example, an accelerometer, such as a piezoelectric accelerometer. The controller 106 can determine structural integrity by comparing a vibration signal obtained from sensor 104 with previously stored vibration signals. For example, the controller 106 can determine the structure integrity of the airfield luminaire based on changes in the vibration signal, such as for example frequency, amplitude (either measured as displacement, acceleration, and/or velocity), or length of time the vibration signal is above a predetermined limit (e.g., 3 dB). The structural integrity of the luminaire can include whether something is loose in the housing 102 (e.g., bolts), support structure (not shown), e.g., an extension, and/or the pavement or the ground (not shown) where the airfield luminaire is mounted. The vibration signal can also differ by the event causing the vibration, for example the peak vibration when a plane passes an airfield luminaire would be greater than the peak vibration when a ground vehicle (e.g., car or maintenance vehicle) passes the airfield luminaire. Thus, the controller 106 can maintain vibration signals for different peaks or ranges of peaks and determine the structural integrity of the airfield luminaire may be deteriorating based on comparing the peak or frequency of a current vibration signal with past signals. For example, deterioration of structural integrity can be determined if the amplitude of vibration signal changes by a predetermined amount (e.g., 2 cm of displacement, 4.9 meters/second/second (or 0.5 g), 16 km/hr,; or a fixed percentage such as ten percent, or a statistical deviation of 1, 2, or 3 standard deviations) and/or the frequency of vibration signal changes by a predetermined amount (such as for example 10 hz, 10%, or a statistical variation of 1, 2, or 3 standard deviations). If the structural integrity is determined to be deteriorating, the controller 106 can take corrective action such as sending a message to an external, remote computing device to report the deterioration of structural integrity and initiate an inspection and/or repair of the light fixture 100 and/or turning the light fixture 100 off.

In still yet another example embodiment, the sensor 104 comprises a plurality of temperature sensors located in the interior 112 of the housing 102. For example, one sensor 104 can be located near the light source 108, another sensor 104 near the controller 106, another sensor 104 near power supply 202, and for example if the light source 108 is an LED, a sensor near the LED and other sensor near the LED electronics. The controller 106 can determine whether there is a malfunction of the airfield luminaire based on a comparison of temperature data from a plurality of temperature sensors associated with the airfield luminaire. For example if one of the temperature sensors is providing a reading that is either higher or lower by a predetermined amount than the rest of the temperature sensors, this can be indicative of a malfunction or failure of a component of the airfield luminaire. For example if the temperature of one of the sensors is more than ten degrees higher, or lower, than the average or mean temperature, or more than ten percent higher, or lower, than the average or mean temperature, and/or the temperature is more than 1, 2, or 3 standard deviations different from mean. Alternatively, kurtosis can be employed to determine if there is an outlier in the temperature measurements. If one or more of the plurality of temperatures is determined to be an outlier when compared to the other temperatures, the controller 106 can take corrective action such as sending a message to an external, remote computing device to report a potential malfunction of the light fixture 100 and initiate an inspection and/or repair of the light fixture 100 and/or turning the light fixture 100 off.

In yet another example embodiment, the sensor 104 comprises an inclinometer. The controller 106 is operable to determine a tilt angle for aiming the light source 108. Based on the tilt angle, the controller 106 is operable to determine if the light source 108 is correctly oriented, which can be very useful for some types of lights, such as for example VASI's and PAPI's. For example, for some lighting devices the FAA requires a tilt angle for the light to be within one-quarter degree of the specified tilt angle. If the tilt angle is determined not to be correctly oriented (e.g., outside of a predefined range), then the controller 106 can take corrective action such as sending a message to an external, remote computing device to report an improper tilt angle and initiate an inspection and/or repair of the light fixture 100 and/or turning the light fixture 100 off.

In still another example embodiment, the sensor 104 comprises a magnetic orientation sensor that can determine the directional orientation of the light source 108. For example, the directional orientation of a unidirectional or bidirectional light. The controller 106 is operable to determine whether the directional orientation of the light source 108 is correct based on the data obtained from the magnetic orientation sensor. For example, the controller 106 can determine if the light source 108 of an airfield luminaire is aligned within a predefined limit (e.g., within one degree) of a specified orientation, For example, is the direction of light from the light source 108 in the same direction (or within a specified tolerance such as one degree) as a runway associated with the airfield luminaire. If the controller 106 determines that the magnetic orientation is incorrect (e.g., not within a predetermined range), then the controller 106 can take corrective action such as sending a message to an external, remote computing device to report the deterioration of structural integrity and initiate an inspection and/or repair of the light fixture 100 and/or turning the light fixture 100 off.

In an example embodiment, the directional orientation of an airfield luminaire can be compared with a previous measured directional orientation. Changes in the directional orientation of the light can be indicative of a problem with the structural integrity of the airfield luminaire. If the controller 106 determines that directional orientation of the light fixture 100 has changed by more than a predefined amount, then the controller 106 can take corrective action such as sending a message to an external, remote computing device to report the deterioration of structural integrity and initiate an inspection and/or repair of the light fixture 100 and/or turning the light fixture 100 off.

In an example embodiment, the controller 106 is operable to determine the remaining life of a light source, such as for example an LED. For example, a factor in the speed at which a LED degrades to the point it needs to be replaced is dependent on the operating temperature, which may be a function on the intensity of the light, the ambient temperature, and the amount of time the light is operated. A LED may need replacement in a few thousand hours or two hundred thousand hours depending on the operating temperature.

In an example embodiment, the controller 106 obtains (or is programmed with) data representative of a light output degradation curve based on output temperature and time. Although, the phrase ‘curve’ is used herein, those skilled in the art can readily appreciate that the degradation curve may be linear or substantially linear.

The controller 106 obtains temperature measurements from a sensor 104 that is operable to measure the LED operating temperature and the amount of time the LED operates that the measured temperature in real time while the LED is operating (e.g., outputting light). For example, the temperature of the circuit board where the LED is located can be measured. As another example, an infrared (IR) scanner can measure the temperature of the LED. As those skilled in the art can readily appreciate, the temperature of the LED can fluctuate over time. Also, in some embodiments the LED operates at different intensities, which would also result in the LED operating at different temperatures. The controller 106 measures the amount of time the LED was operated at a plurality of temperatures.

The controller 106 is operable to determine a present LED light output based on calculating the amount of degradation for a plurality of measured temperatures and a time period operating at the plurality of temperature from the LED aging rate for the plurality of temperatures from an initial light output. For the plurality of operating temperatures, the controller 106 can determine an amount of degradation of the LED for that temperature based on the amount of time the LED was operating at that temperature. The aging rate for temperatures that were not programmed into the controller 106 can be interpolated. The sum of the light output degradation for the plurality of the operating temperatures can be subtracted from the initial light output to obtain the present LED output. In an example embodiment, based on the present LED output, and/or a plurality of previously determined LED light outputs, the controller 106 can determine a rate that the light source 108 is degrading and further provide an estimate on when the light source 108 will need replacing.

In an example embodiment, the controller 106 is operable to cause an indication of the present LED light output to be outputted responsive to determining that the present LED light output has achieved a predetermined threshold. For example, the controller 106 can cause a signal to be sent via communication interface 110 to an external, remote controller such as an ALCMS for alerting airfield personnel that the light source 108 should be replaced. In other embodiments, the controller 106 can turn off the light fixture 100 in response to determining the LED has deteriorated beyond a predefined threshold. For example, the FAA requires the light source 108 of an airfield luminaires to be replaced when the light output reaches 70% of its initial output. The ICAO requires the light source 108 of an airfield luminaire to be replaced when the light output reaches 50% of its initial output.

In an example embodiment, the determined LED light output can be compared with measured LED light output that measures light from the light source 108. Light that is measured from the light source 108 can be impacted by factors such as improper aiming of the light or dirt on the lens. Therefore, if the determined LED light output and measured light output differ by more than a predetermined amount (e.g., 2%), the controller 106 can send an alert to check the light for proper alignment and/or dirt on the lens. This may prevent needless replacing of a LED.

A LED can become permanently damaged if operated at too high a temperature. In an example embodiment, controller 106 generates an alert if the operating temperature for a LED exceeds a predetermined threshold, such as a manufacturer's specified operating limit. For example, for an airfield luminaire, the alert can be sent to an external remote computing device such as an ALCMS via communication interface 110. In particular embodiments, the controller 106 may turn off the light fixture 100 in response to determining the operating temperature of a LED exceeded a predetermined threshold.

FIG. 2 is a simplified functional block diagram illustrating an example of a light fixture 300 that can be employed as an airfield luminaire that communicates control signals and/or sensor data over a powerline 202. The light fixture 300 comprises a power supply 202 operable receive power data signals via the powerline 204. The power signal is provided to the components within the light fixture 100, such as for example the light source 108, controller 106, and communication interface 110 and depending on the type of sensor, to sensor 104. As those skilled in the art can readily appreciate, the power supply 202 can provide different levels of voltage and/or current to the light source 108, controller 106, communication interface 110, and if power is being provided, to the sensor 104.

Data signals are provided by the power supply 202 to the communication interface 110 and are processed by the communication interface 110. In some embodiments, the communication interface 110 is integrated with the power supply 202. Incoming data signals received from powerline 204 are routed through the power supply 202, to the communication interface 110 the controller 106, Data being sent by either the controller 106 or from the sensor 104 are routed through the communication interface 110 to the power supply 202 and the powerline 204.

In an example embodiment, the data signals received from the powerline 204 comprises commands for controlling the operation of the light source 108. The commands are provided to controller 106 and causes the light source 108 to operate in accordance with the commands. Data signals from the sensor 104 are sent to an external, remote device via the powerline 204.

In an example embodiment, data communication on the powerline 204 is performed in a frequency range using a number of frequency bands within the frequency range. In particular embodiments, Orthogonal Frequency Domain Multiplexing (“OFDM”) is employed for data communication.

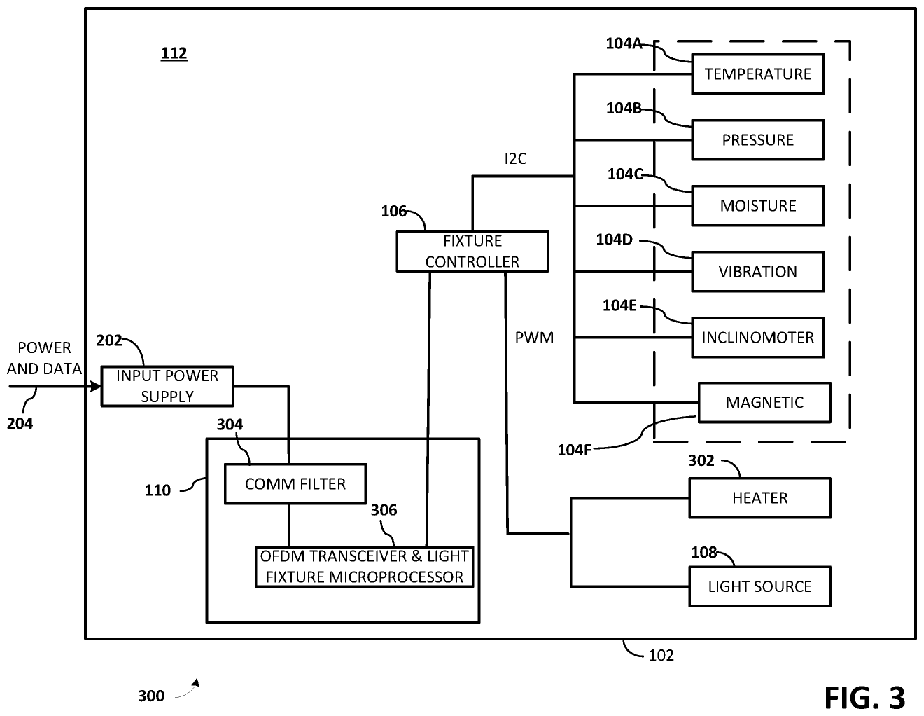

FIG. 3 is a block diagram illustrating an example of a light fixture 300 with an integrated controller that employs powerline communications and illustrates examples of different types of sensors that can be employed in the light fixture 300. The types of sensors in the illustrated example comprise a temperature sensor 104A, a pressure sensor 1048, a moisture sensor 104C, a vibration sensor 104D, an inclinometer 104E, and magnetic sensor 104F. As those skilled in the art can readily appreciate, other embodiments may have only a single sensor, or any combination of two, three, or four of the aforementioned embodiments. Other embodiments can include the aforementioned sensors combined with other sensors not listed herein. In the illustrated example, the fixture controller 106 comprises a microprocessor (not shown, see e.g., FIG. 5) that communicates with the sensors 104A-104F employing an Inter-Integrated Circuit (“I²C” or “I2C”) Protocol and employs Pulse Width Modulation (“PWM”) to communicate with and/or power the heater 302 (for those embodiments that have a heater) and the light source 108.

The temperature sensor 104A can be any suitable type of sensor for measuring temperature within the interior 112 of the housing 102. As described herein, a temperature sensor can be employed to detect a malfunction, failure, or other problems with a light fixture or a component within the interior 112 of housing 102. In some embodiments, a combination of measurements from the temperature sensor and the pressure sensor 104B are employed for detecting leaks in the housing 102. Examples of temperature sensors 104A are a thermometer and/or an infra-red (“IR”) sensor.

The pressure sensor 104B can be any suitable sensor for measuring the pressure within the interior 112 of the housing 102. As described herein, the pressure sensor 104B can be employed to detect leaks in the housing 102. Examples of pressure sensors include, but are not limited to, strain gauges, piezoelectric sensors, and/or an aneroid barometer.

Moisture sensor 104C can be any suitable sensor for detecting liquid and/or humidity. As described herein, the moisture sensor can be employed to detect leaks in the housing 102. In an example embedment, leaks may be detected by the moisture sensor 104C or, as described herein measurements from the moisture sensor can be combined with can be combined with measurements from the temperature sensor 104A to detect leaks. Examples of moisture sensors include, but are not limited to a water sensor and/or a hygrometer.

The vibration sensor 104D detects movement of the housing 102. This can determine whether a component of the housing 102 is loosening, for embodiments employing a mount whether the mount is loosening, and/or whether the surface where the light fixture 500 is deployed is loosening (e.g., pavement or concrete). Any suitable sensor for detecting movement of the housing 102 can be employed, such as for example a piezoelectric sensor.

The inclinometer 104E is aligned with the output (e.g., direction) of the light source 108 and measures the tilt angle for aiming the light source 108. Certain types of airfield lights such as for example VASI's and PAPI's require the light output from the light source 108 be directed at a predefined angle. The inclinometer 104E can determine whether the light output from the light source 108 is correctly aligned.

The magnetic sensor 104F is aligned with the output (e.g., direction) of the light source 108 and measures the magnetic orientation with respect to the Earth's magnetic field for aiming the light source 108. For bi-directional or other multi-directional lights, the magnetic sensor 104F can be aligned with a selected directional beam. Use of the magnetic sensor 104F can ensure that the light output from the light source 108 is properly orientated, such as aligned with an associated runway or taxiway.

In an example embodiment, the light fixture 500 further comprises a heater 302. The heater 302 may be employed in airfield luminaires where the light source 108 (such as LED's) does not generate enough heat to melt ice and snow.

The input signal is received on the powerline 204 is provided to the input power supply 202 and the light fixture controller 106. In an example embodiment, the input power supply 202 is operable to filter out the OFDM signals from the power signal and provides power signal to the light fixture 300. The light fixture 100 comprises a communication (COMM) filter 304 that filters out the power signal from the data signal received on powerline 204 and provides the data signal to the OFDM transceiver 306, which provides the data signal to the fixture controller 106. The controller 106 can process the data signals and send the appropriate commands and/or signals to the light source 108.

The fixture controller 106 can send data signals to an ALCMS via the OFDM transceiver 306. The OFDM transceiver 306 provides the modulated data signals to the powerline 204 through power supply 202.

In an example embodiment, the controller 106 is operable to process the sensor data received from the sensors 104A0-104F, or any other sensor. This can allow for quicker control action in situations that require a faster response than could be provided by a remote controller. In particular embodiments, the controller 106 selectively forwards sensor data from one or more selected sensors through the OFDM transceiver 306, power supply 202 and powerline 204.

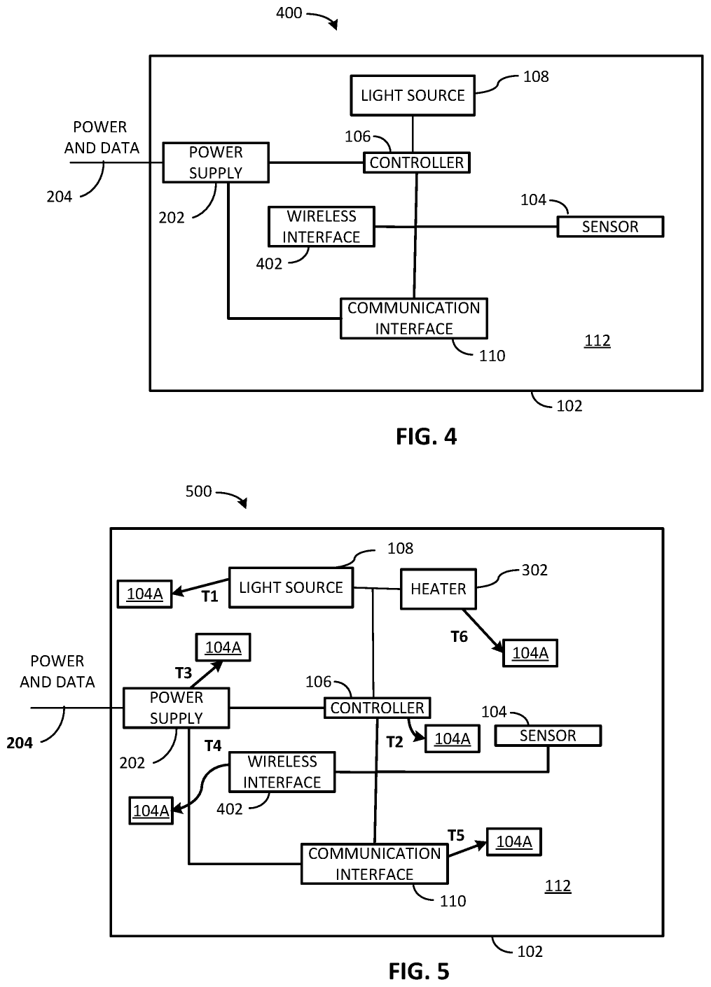

FIG. 4 is a block diagram illustrating an example of a light fixture 400 with an additional wireless communication interface 402 for enabling communication with external portable mobile devices (not shown). Examples of wireless technologies that can be employed by wireless interface 402 can employ include, but are not limited to, BLUETOOTH, Wi-Fi, Near Field Communication (“NFC”), and/or cellular technologies.

In an example embodiment, a user with a mobile device can obtain data from sensor 104 via the wireless interface 402. In another example embodiment, a user can send commands to the controller 106 via the wireless interface 402. For example, if a user wants to see if the light source 108 is working properly the user can send a command to turn the light on, and if desired specify operating parameters such as intensity and/or blink rate. In still yet another example embodiment, a user with a mobile device can receive sensor data from sensor 104 and send commands to controller 106 via wireless interface 402.

FIG. 5 is a block diagram illustrating an example of a light fixture with a plurality of temperature sensors 104A within the housing. In an example embodiment, the temperature sensors 104A can be employed with other sensors 104. Examples of temperatures that can be measured by the temperature sensors 104A, include but are not limited to, temperature of the light source 108 or a component within the light source 108 (e.g., LED junction temperature), represented by T1, temperature of the controller 106 (e.g., a microprocessor or circuit board associated with controller 106) represented by T2, the power supply 202 represented by T3, in embodiments which have a wireless interface, the wireless interface 402 represented by T4, the communication interface 110 represented by T5, and the heater 302 represented by

T6.

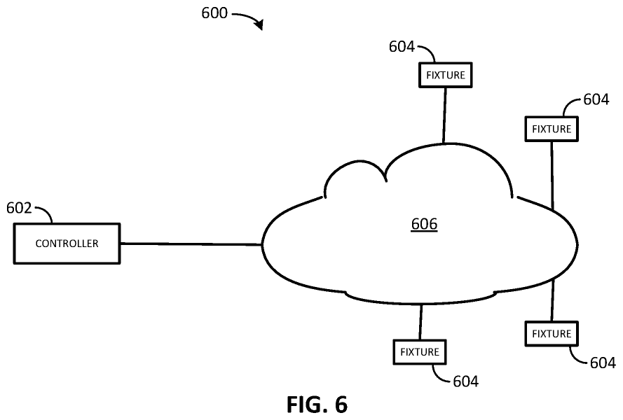

In an example embodiment, the controller 106, or other external remote computing device, see e.g., controller 602 in FIG. 6, can determine whether there is a malfunction of an airfield luminaire based on a comparison of temperature data (T1 . . . T6) from a plurality of temperature sensors associated with the airfield luminaire. For example if one of the temperature sensors is providing a reading that is either higher or lower by a predetermined amount than the rest of the temperature sensors, this can be indicative of a malfunction or failure of a component of the airfield luminaire. For example of the temperature of one of the sensors is more than ten degrees higher than the average or mean temperature, or more than ten percent higher than the average or mean temperature, and/or the temperature is more than 1, 2, or 3 standard deviations different from mean. Alternatively, kurtosis can be employed to determine if there is an outlier in the temperature measurements. In an example embodiment, the temperature represented by T6 can determine whether the heater 302 is functioning properly.

FIG. 6 is a block diagram illustrating an example of a system 600 comprising a remote computing device 602 operable to determine the status of a plurality of light fixtures 604. The controller 602 comprises logic for performing the functionality described herein. In an example embodiment, the controller 602 is an ALCMS.

The controller 602 is coupled with a plurality of light fixtures 604 via network 606. In an example embodiment, the light fixtures 604 are airfield luminaires. The light fixtures 604 can be configured similar to light fixture 100 (FIG. 1), light fixture 200 (FIG. 2), light fixture 300 (FIG. 3), light fixture 400 (FIG. 4) and/or light fixture 500 (FIG. 5).

The network 606 can be any suitable type of network. The network 606 may comprise wired, wireless or a combination of wired and wireless links. In an example embodiment, the network 606 is employed for providing both power and data to light fixtures 604 and can provide data from the light fixtures 604 to the controller 602.

As will be described herein, the controller 602 is operable to determine a status of airfield luminaires based on sensor data obtained from the light fixtures 604. The data sent to the controller 602 can include, but is not limited to, data representative of the current operational state of the light source 108, within the fixture 604, (e.g., on/off, blinking, intensity, etc.).

In an example embodiment, the controller 602 can determine if there is a leak in the housing 102 of a light fixture 604 by comparing changes in temperature obtained from the light fixture 604 with changes in pressure obtained from the light fixture 604. A temperature increase or decrease without a corresponding increase or decrease in pressure can indicate a leak in the light fixture 604. For example if the temperature increases or decreases by more than ten degrees Celsius without a change in pressure, the controller 106 can determine there is a leak in the housing 102. In an example embodiment, the ratio of the temperature and pressure is computed and stored by controller 106. The ratio of temperature and pressure should be constant, so if the controller 106 determines the ratio has been changing over time, or there is a sudden change, by more than a predetermined amount, a leak can be detected. The predetermined amount can be based on a fixed number of degrees (e.g., 10° C.), a percentage change (e.g., 10% or more), and/or based on statistical analysis (e.g., more than 1, 2, or 3 standard deviations). In response to detecting a leak, the controller 602 can take corrective action such as reporting the detected leak and/or turning off the light fixture 604 where the leak was detected.

In another example embodiment, the sensor data obtained from the light fixture 604 comprises data from a moisture sensor and the controller 602 can determine if there is a leak in one of the plurality of light fixtures 604 based on moisture data obtained from the one of the plurality of light fixture 604. For light fixtures 604 that employ sensors that detect water, any water detected in the interior the light fixture 604 can be indicative of a leak. For light fixtures 604 that employ sensors that detect humidity, the controller 602 may also employ data from a temperature sensor for determining relative humidity. The amount of moisture within a light fixture 604 should remain constant, thus a change in temperature without a corresponding change in relative humidity can be indicative of a leak. For example, as temperature increases, the relative humidity should decrease. For example, if the temperature changes by more than ten degrees Celsius without a corresponding change in relative humidity, the controller 106 can determine there is a leak in housing 102. In response to detecting a leak, the controller 602 can take corrective action such as reporting the detected leak and/or turning off the light fixture 604 where the leak was detected.

Alternatively, the controller 602 can compute the absolute humidity and/or the specific humidity for the light fixtures 604 and can determine if there is a leak in one of the plurality of light fixtures 604 by detecting changes in the absolute humidity and/or the specific humidity by more than a predetermined amount. The predetermined amount of change for absolute humidity can be a fixed amount (e.g., more than 2 g/cubic meter (g water vapor/cubic meter of air), a fixed percentage (e.g. more than 10%, or a statistically computed amount such as 1, 2, or 3 standard deviations). The predetermined amount of change for specific humidity can be a fixed number, based on a percentage, or based on statistical variations. For example, for specific humidity a change of more than by more 2 g/kg (g air/kg water), or a ten percent change, or a 1, 2, or 3 standard deviation can be indicative of a leak in housing 102. In response to detecting a leak, the controller 602 can take corrective action such as reporting the detected leak and/or turning off the light fixture 604 where the leak was detected.

In yet another example embodiment, controller 602 obtains data from a vibration sensor from at least one of the plurality of light fixture 604. The controller 602 can determine structural integrity of any of the plurality of light fixtures 604 by comparing a vibration signal obtained previously stored vibration signals for that light fixture. For example, the controller 602 can determine the structure integrity of any of plurality of light fixture 604 based on changes in the vibration signal, such as for example frequency, amplitude (either measured as displacement, acceleration, and/or velocity), or length of time the vibration signal is above a predetermined limit (e.g., 3 dB). The structural integrity of the light fixtures 604 can include whether something is loose in the housing (e.g., housing 102 in FIGS. 1-5), such as bolts, the support structure, e.g., an extension, and/or the pavement or the ground where the light fixtures are mounted. The vibration signal can also differ by the event causing the vibration, for example the peak vibration when a plane passes an airfield luminaire would be greater than the peak vibration when a ground vehicle (e.g., car or maintenance vehicle) passes the airfield luminaire. Thus, the controller 602 can maintain vibration signals for different peaks or ranges of peaks and determine whether the structural integrity the light fixture 604 may be deteriorating based on comparing the peak or frequency of a current vibration signal with past signals. For example, deterioration of structural integrity can be determined if the amplitude of vibration signal changes by a predetermined amount (e.g., 2 cm of displacement, 4.9 meters/second/second (or 0.5 g), 16 km/hr,; or a fixed percentage such as ten percent, or a statistical deviation of 1, 2, or 3 standard deviations) and/or the frequency of vibration signal changes by a predetermined amount (such as for example 10 hz, 10%, or a statistical variation of 1, 2, or 3 standard deviations). In response to detecting the deterioration of a light fixture 604, the controller 602 can take corrective action such as reporting the detected problem with the structural integrity and/or turning off the light fixture 604 where the deterioration was detected.

In an example embodiment, the controller 602 can obtain vibration data from the plurality of light fixtures 604 and determine whether structural integrity of one of the plurality of light fixtures 604 is deteriorating by comparing the vibration data obtained from the plurality of light fixtures 604. For example, deterioration of structural integrity can be determined if the amplitude of vibration signal from one of the plurality of light fixtures 604 differs from the other light fixtures by a predetermined amount (e.g., 2cm of displacement, 4.9 meters/second/second (or 0.5 g), 16 km/hr,; or a fixed percentage such as ten percent, or a statistical deviation of 1, 2, or 3 standard deviations) and/or the frequency of vibration signal changes by a predetermined amount (such as for example 10 hz, 10%, or a statistical variation of 1, 2, or 3 standard deviations). In an example embodiment, kurtosis can be employed to detect and identify outliers. If the controller 106 determines that structural integrity of one or more of the vibration signals from the plurality of light fixtures is different by the predetermined amount, then the controller 106 can take corrective action such as sending a message to an external, remote computing device to report the deterioration of structural integrity and initiate an inspection and/or repair of the light fixture 604 and/or turning the light fixture 604 off.

In still yet another example embodiment, the sensor data obtained from the plurality of light fixtures 604 comprises a plurality of temperature sensors located within the plurality of light fixtures 604, controller 602 can determine whether there is a malfunction of the airfield luminaire based on a comparison of temperature data from a plurality of temperature sensors associated with the airfield luminaire. For example if one of the temperature sensors is providing a reading that is either higher or lower by a predetermined amount than the rest of the temperature sensors, this can be indicative of a malfunction or failure of a component of the airfield luminaire. For example if the temperature of one of the sensors is more than ten degrees higher than the average or mean temperature, or more than ten percent higher than the average or mean temperature, and/or the temperature is more than 1, 2, or 3 standard deviations different from mean. Alternatively, kurtosis can be employed to determine if there is an outlier in the temperature measurements. If the controller 602 determines a potential malfunction based on the comparison of temperature data for the plurality of light fixtures, the controller 106 can take corrective action such as sending a message to an external, remote computing device to report the potential malfunction of the one or more light fixtures 604 and initiate an inspection and/or repair of the light fixture 604 and/or turning the one or more of the plurality of light fixtures 604 off.

In yet another example embodiment, the sensor data that the controller 602 receives from the plurality of light fixtures 604 comprises a tilt angle from an inclinometer. Based on the tilt angle, the controller 602 is operable to determine if the light source is correctly oriented, which can be very useful for some types of lights, such as for example VASI's and PAPI's. For example, for some lighting devices the FAA requires a tilt angle for the light to be within one-quarter degree of the specified tilt angle. Upon detecting that one or more of the plurality of light fixtures 604 is misaligned, the controller 602 can take other corrective actions such as shutting off the light fixture 604 that is misaligned, shutting of the plurality of light fixtures 604. In particular embodiments, the controller 602 generates a Notice to Airmen (“NOTAM”) upon detecting a misaligned light fixture 604.

In still another example embodiment, the sensor data obtained from the plurality of light fixtures 604 comprises the magnetic orientation for the plurality light fixtures 604. For example, the directional orientation of a unidirectional or bidirectional light. The controller 602 is operable to determine whether the directional orientation of any of the plurality of light fixtures 604 is correct based on the data obtained from the magnetic orientation sensor. For example, the controller 602 can determine if a light fixture 604 is aligned within a predefined limit (e.g., within one degree) of a specified orientation, For example, the controller 602 can determine if the direction of light from a light fixtures 604 is in the same direction (or within a specified tolerance such as one degree) as a runway associated with the light fixture 604.

In an example embodiment, controller 602 compares the directional orientation of any of the plurality of light fixtures 604 with a previous measured directional orientation. Changes in the directional orientation of a light fixture 604 can be indicative of a problem with the structural integrity of the airfield luminaire.

In an example embodiment, the controller 602 is operable to determine the remaining life of a light source, such as for example an LED for the plurality of light fixtures 604. A LED may need replacement in a few thousand hours or two hundred thousand hours depending on the operating temperature.

In an example embodiment, the controller 602 obtains (or is programmed with) data representative of a light output degradation curve for individual light fixtures selected from the plurality of light fixtures 604 based on output temperature and time. Although, the phrase ‘curve’ is used herein, those skilled in the art can readily appreciate that the degradation curve may be linear or substantially linear.

The controller 602 obtains the LED operating temperature and the amount of time the LED operates for any one or all of the plurality of light fixtures 604. As those skilled in the art can readily appreciate, the temperature of the LED can fluctuate over time. Also, in some embodiments (such as airfield luminaires), the LED operates at different intensities, which would also result in the LED operating at different temperatures. The controller 602 measures the amount of time the LED was operated at the plurality of temperatures.

The controller 602 is operable to determine a present LED light output of a light fixture 604 based on calculating the amount of degradation for a plurality of measured temperatures and a time period operating at a plurality of temperatures from the LED aging rate for the plurality of temperatures from an initial light output. For the plurality of operating temperatures, the controller 602 determines an amount of degradation of the LED for that temperature based on the amount of time the LED was operating at that temperature. The aging rate for temperatures that were not programmed into the controller 602 can be interpolated. The sum of the light output degradation for the plurality of operating temperatures can be subtracted from the initial light output to obtain the present LED output. In an example embodiment, based on the present LED output, and/or a plurality of previously determined LED light outputs, the controller 602 can determine a rate that the light source for a light fixture is degrading and further provide an estimate on when the light source for the light fixture 604 will need replacing.

In an example embodiment, the controller 602 is operable to cause an indication of the present LED light output to be outputted responsive to determining that the present LED light output has achieved a predetermined threshold. For example, the controller 602 can cause an alert to be provided to airfield personnel that the light source of a light fixture 608 should be replaced. For example, the FAA requires the light source of an airfield luminaires to be replaced when the light output reaches 70% of its initial output. The ICAO requires the light source 108 of an airfield luminaire to be replaced when the light output reaches 50% of its initial output.

In an example embodiment, the determined LED light output for a light fixture 604 can be compared with measured light output that measures light output from the light fixture 604. Light output that is measured from the light source 108 can be impacted by factors such as improper aiming of the light and/or dirt on the lens. Therefore, if the determined LED light output and measured light output differ by more than a predetermined amount (e.g., 2%), the controller 602 can cause an alert to check the light for proper alignment and/or dirt on the lens. This may prevent needless replacing of a LED for a light fixture 604.

In an example embodiment, the controller 602 can take other corrective action if one or more (or all) of the plurality of light fixture's output has dropped below the predetermined threshold. For example, the controller 602 can shut off the light fixture that is below the threshold, a group of lights associated with a light fixture 604 that is below the threshold, or all of the light fixtures 604. In particular embodiments, the controller 602 can generate a NOTAM.

Although the example illustrated in FIG. 6 employs light fixtures, such as airfield luminaires, those skilled in the art can readily appreciate the illustrated embodiments were selected merely for ease of illustration and that the principles described in the example embodiments described herein can be employed to obtain sensor data from any suitable type of devices with communication capabilities, Therefore, the description herein should not be construed as limited to airfield luminaires.

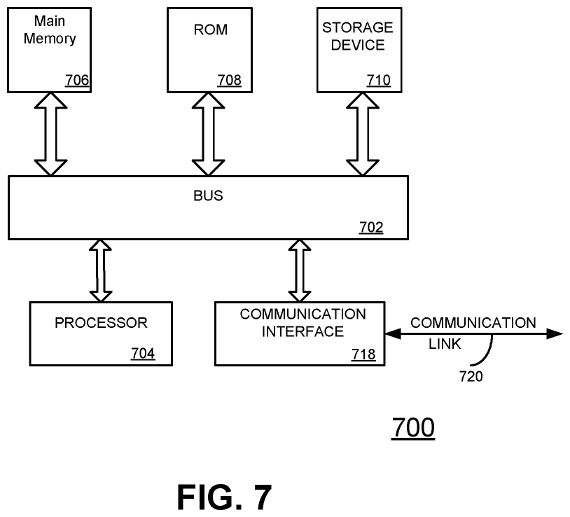

FIG. 7 is a block diagram of a computer system 700 upon which an example embodiment can be implemented. Computer system 700 can be employed to implement the controller 106 (FIGS. 1-5) and/or the controller 602 (FIG. 6).

Computer system 700 includes a bus 702 or other communication mechanism for communicating information and a processor 704 coupled with bus 702 for processing information. Computer system 700 also includes a main memory 706, such as random access memory (RAM) or other dynamic storage device coupled to bus 702 for storing information and instructions to be executed by processor 704. Main memory 706 also may be used for storing a temporary variable or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

An aspect of an example embodiment is related to the use of computer system 700 for an Airfield Ground Light with Integrated Light Controller That Employs Powerline Communications and Sensors. According to one embodiment, operation of the Airfield Ground Light with Integrated Light Controller That Employs Powerline Communications and Sensors is provided by computer system 700 in response to processor 704 executing one or more sequences of one or more instructions contained in main memory 706. Such instructions may be read into main memory 706 from another computer-readable medium, such as storage device 710. Execution of the sequence of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media. Non-volatile media include for example optical or magnetic disks, such as storage device 710. Common forms of computer-readable media include for example RAM, PROM, EPROM, FLASHPROM, CD, DVD, SSD or any other memory chip or cartridge, or other medium from which a computer can read.

Computer system 700 also includes a communication interface 718 coupled to bus 702. Communication interface 718 provides a two-way data communication coupling to a network link 720 that is connected to a network (not shown, see e.g., network 606 in FIG. 6). For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Communication link 720 typically provides data communication through one or more networks to other data devices. For example, communication link 720 can provide communications to the sensors or other components described herein.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An airfield luminaire, comprising:
a housing;
a light source in an interior of the housing;
a sensor for sensing a condition associated with the housing;
control logic comprising a processor coupled with the light source and the sensor, the control logic is operable to:
obtain data from the sensor, the sensor selected from a group consisting of a combination of a temperature sensor and a pressure sensor for sensing pressure inside the airfield luminaire, a moisture sensor for sensing a leak inside the airfield luminaire, a vibration sensor, an inclinometer, and a magnetic field sensor; and
determine a status of the airfield luminaire, the status selected from a group consisting of a leak in the housing determined by comparing changes in temperature obtained from the temperature sensor with changes in pressure obtained from the pressure sensor, a leak in the housing based on moisture data obtained from the moisture sensor, status of a structural integrity of the airfield luminaire based on a comparison of data representative of a vibration signal obtained from the vibration sensor with a previously stored vibration signal, a malfunction of the airfield luminaire based on a comparison of temperature data from a plurality of temperature sensors associated with the airfield luminaire, a tilt angle with respect to gravity of the light source based on data obtained from the inclinometer, a directional orientation of the light source based on data obtained from the magnetic field sensor, and whether the light source is correctly aimed based on a comparison of tilt angle with respect to gravity data obtained from the inclinometer and directional orientation data obtained from the magnetic field sensor with a predefined tilt angle and a predefined directional orientation.

2. The apparatus set forth in claim 1, further comprising:
a power supply circuit that is operable to receive a powerline signal and communicate data over the powerline signal;
wherein the data received from the powerline signal comprises commands for controlling operation of the light source; and
wherein the data sent to the external, remote device comprise data representative of sensor data from the sensor.

3. The apparatus set forth in claim 2, wherein data communication is performed in a frequency range using a number of frequency bands within the frequency range.

4. The apparatus set forth in claim 2, wherein Orthogonal Frequency Domain Multiplexing is employed for data communication.

5. The apparatus set forth in claim 4, further comprising:
a wireless transceiver coupled with the control logic; and
the control logic is further operable to send data from the sensor to an external, remote wireless device via the wireless transceiver.

6. The apparatus set forth in claim 5, wherein the wireless transceiver is a Wi-Fi transceiver.

7. The apparatus set forth in claim 5, wherein the wireless transceiver is a BLUETOOTH transceiver.

8. The apparatus set forth in claim 5, wherein the wireless transceiver is a Near-Field Communication transceiver.

9. The apparatus set forth in claim 1, wherein the sensor is a moisture sensor that is a water leak detector.

10. The apparatus set forth in claim 1, wherein the sensor is a moisture sensor that is a hygrometer.

11. The apparatus set forth in claim 1, wherein the sensor is a vibration sensor that is an accelerometer.

12. An apparatus, comprising:
a controller operable to communicate with a plurality of airfield lighting fixtures, the controller comprises logic comprising a processor operable to:
receive data representative of sensor data, the sensor data selected from a group consisting of vibration signals from the plurality of airfield lighting fixtures and data representative of a plurality of temperatures from the plurality of airfield lighting fixtures; and
determine a status of a selected one of the plurality if lighting fixtures, the status selected from a group consisting of a structural integrity based on a comparison of the plurality of vibration signals and determining whether the vibration signal from the selected one of the plurality of lighting fixture indicates the selected one airfield lighting fixture is vibrating more than other airfield lighting fixtures from the plurality of airfield lighting fixtures, and a fixture malfunction based on a comparison of temperature data from the selected one of the plurality of airfield lighting fixtures with other airfield lighting fixtures of the plurality of airfield lighting fixtures.

13. The apparatus set forth in claim 12, wherein the sensor data comprises vibration signals and the determined status comprises structural integrity based on a comparison of the plurality of vibration signals from the plurality of lighting fixtures and determining whether the vibration signal from the selected one of the plurality of lighting fixture indicates the selected one airfield lighting fixture is vibrating more than other airfield lighting fixtures from the plurality of airfield lighting fixtures based on a measurement of one of a group consisting of frequency of vibration, length of time vibrating, and amplitude of vibration signal.

14. The apparatus set forth in claim 12, wherein the sensor data comprises data representative of a plurality of temperatures from the plurality of airfield lighting fixtures and the determined status comprises a fixture malfunction based on a comparison of temperature data from the selected one of the plurality of airfield lighting fixtures with other airfield lighting fixtures of the plurality of airfield lighting fixtures.

15. The apparatus set forth in claim 14, where a fixture malfunction is determined when the temperature of the selected one of the plurality of lighting fixtures is greater than other of the plurality of lighting fixtures by a predetermined amount.

16. The apparatus set forth in claim 14, where a fixture malfunction is determined when the temperature of the selected one the plurality of lighting fixtures is less than other of the plurality of lighting fixtures by a predetermined amount.

17. The apparatus set forth in claim 12, further comprising:
at least one circuit providing power to the plurality of airfield lighting fixtures; and
the controller is coupled with least one circuit providing power to the plurality of airfield lighting fixtures and operable to communicate with the plurality of airfield lighting fixtures via the circuit.

18. An apparatus, comprising:
control logic comprising a processor that is operable to:
obtaining a light emitting diode (“LED”) light output aging rate for an LED;
measuring operating temperature and an amount of time the LED operates at the operating temperature in real time during operation of the LED; and
determining a present LED light output based on calculating an amount of degradation for a plurality of measured temperature and a time period operating at the plurality of temperature from the LED aging rate for the plurality of temperatures from an initial light output.

19. The apparatus set forth in claim 18, further comprising outputting an indication responsive to determining that the present LED light output has achieved a predetermined threshold.

20. The apparatus set forth in claim 19, wherein the predetermined threshold is selected from a group consisting of 50% of an initial light output 70% of the initial light output.
